(19) United States
(12) Patent Application Publication
(10) Pub. No.: US 2007/0167069 A1
(43) Pub. Date: Jul. 19, 2007

(54) ELECTRONIC APPARATUS, CONTROL METHOD THEREFOR, PROGRAM, AND COMPUTER-READABLE RECORDING MEDIUM

(75) Inventor: Naotaka Murakami, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/621,008

(22) Filed: Jan. 8, 2007

(30) Foreign Application Priority Data
Jan. 13, 2006 (JP) 2006-006291
Dec. 20, 2006 (JP) 2006-343246

(51) Int. Cl. H01R 11/00

(52) U.S. Cl. 439/502

(57) ABSTRACT

An electronic apparatus including a plurality of operation modes determines a operation mode of an electronic device and notifies a user of an appropriate plug type for a communication line based on the determination of the operation mode so that selecting wrong connection using an incorrect plug for the communication line can be prevented at an early stage when devices are connected with each other.

### BACKGROUND OF THE INVENTION

1. Field of the Invention

The present invention relates to an electronic apparatus capable of communicating with another device through a communication line; and a control method, a program, and a computer-readable recording medium to be implemented in the apparatus.

2. Description of the Related Art

A universal serial bus (USB) standard has been used as a standard of data transmission paths for connecting a peripheral device such as a keyboard, a mouse, a digital camera, a printer, and an external storage, with a personal computer.

In conventional USB communication, it has been assumed that the personal computer functions as a host device that can be connected to peripheral devices. In such a case, the personal computer which functions as the host device is necessary, and the peripheral devices cannot communicate with each other.

Consequently, the USB On-The-Go (OTG) standard has been established as an additional standard of the USB in which the peripheral devices can communicate with each other without using the personal computer. According to the OTG standard, dual-role devices can operate as either a host or peripheral device, and communication between peripheral devices can be realized.

Pursuant to the OTG standard, plugs and receptacles are specified. First, as connectors of the conventional USB standard, a standard A plug, a standard A receptacle, a standard B plug, a standard B receptacle, a Mini-B plug, and a Mini-B receptacle are specified. Further, a Mini-A plug, Mini-A receptacle, and Mini-AB receptacle are newly specified. The dual-role devices based on the OTG standard are equipped with the Mini-AB receptacle. Into the Mini-AB receptacle, either the Mini-A plug or the Mini-B plug can be inserted. The dual-role devices can change operation status of the devices depending on the type of the inserted plug. More specifically, if the Mini-A plug is inserted into the dual-role device, the device functions as a host device by default. On the contrary, if the Mini-B plug is inserted into the dual-role device, the device functions as a peripheral device by default.

With such a feature, the devices based on the OTG standard can communicate with each other without using the personal computer.

In the communication between the dual-role devices, depending on the type of plug inserted into each device, it is determined which device first functions as the host device and which device functions as the peripheral device. However, with a host negotiation protocol (hereinafter, referred to as HNP) according to the OTG standard, the dual-role devices can switch the roles of the host device and the peripheral device with each other.

With the HNP, when a user wants to use a specific dual-role device as a host device, the user does not need to confirm the plug type, but any plug type can be inserted. If the Mini-A plug is inserted into the dual-role device, the dual-role device functions as the host device by default. In such a case, because the device functions as the host device, there is no problem. If the Mini-B plug is inserted into the dual-role device, the dual-role device functions as a peripheral device by default. But, even in this case, with the HNP, the roles of the host and the peripheral device can be switched between the communicating devices, and the dual-role device can function as the host device.

However, as new connecters are specified based on the OTG standard, types of available cables are increasing. This causes confusion to users about how to connect the devices. FIGS. 8 to 11 illustrate types of plugs and cables which can be connected to a digital camera 1 according to the USB OTG standard.

FIG. 8 shows that a Mini-A plug 50 is inserted into a Mini-AB receptacle 26 of the digital camera 1, and a standard B plug 51 is inserted into a printer 53 which communicates with the camera and is equipped with a standard B receptacle 52.

FIG. 9 shows that the Mini-A plug 50 is inserted into the Mini-AB receptacle 26 of the digital camera 1, and a Mini-B plug 54 is inserted into a printer 56 which communicates with the camera and is equipped with a Mini-B receptacle 55.

FIG. 10 shows that the Mini-B plug 54 is inserted into the Mini-AB receptacle 26 of the digital camera 1, and a standard A plug 57 is inserted into a personal computer 59 which communicates with the camera and is equipped with a standard A receptacle 58.

FIG. 11 shows that a Mini-A plug 54 is inserted into the Mini-AB receptacle 26 of the digital camera 1, and the Mini-A plug 50 is inserted into a personal computer 61 which communicates with the camera and is equipped with a Mini-A receptacle 60.

With respect to the digital camera 1, the connection forms shown in FIGS. 8 to 11 can be assumed. There are two types of plugs which can be inserted into the digital camera 1, and three types of cables can be used. Accordingly, there are various combinations of the plugs and cables which can be inserted. Therefore, it is possible that users choose incorrect plugs or cables.

In a conventional technique, by using a dedicated USB cable, a connection method between devices can be defined so that incorrect connection is prevented. However, according to the technique, the general cables specified by standards cannot be used.

When a dual-role device is connected with the other device, depending on operation status of the dual-role device or the other device, the devices are required to function as a host device or a peripheral device. In such a case, it is possible that a specific plug has to be inserted into the Mini-AB receptacle.

If a device which operates only as the peripheral device is connected to the dual-role device, it is necessary to insert the Mini-A plug into the dual-role device to operate the dual-role device as a host device. For example, a digital camera is a dual-role device and equipped with a Mini-AB receptacle. And an external storage is equipped with only a Mini-B receptacle and functions only as a peripheral device. Now, the digital camera and the external storage are connected with each other. With respect to a cable to be used in such a case, one end of the cable is a Mini-A plug and the other end is a Mini-B plug.

In the above case, if the external storage is a dual-role device, with the HNP, the roles of the devices can be switched between the host device and the peripheral device. Accordingly, if the Mini-B plug is inserted into the Mini-AB receptacle of the digital camera which is expected to function as the host device, first, the digital camera functions as the peripheral device, and then, with the HNP, the digital camera can become the host device. However, if the external device is not the dual-role device, only the digital camera which is the dual-role device, can function as the host device. Accordingly, the Mini-A plug has to be surely inserted into the digital camera.

In this case, a connecter of the external storage which operates only as the peripheral device has a shape which accepts only the Mini-B plug. The user can insert only the Mini-B plug into the external storage. Accordingly, if the Mini-B plug at one end of the cable is firstly inserted into the external storage, the Mini-A plug at the other end of the cable is inserted into the digital camera, and the connection is correctly carried out. However, into the Mini-AB receptacle of the digital camera, either plug of the cable can be physically inserted. Thus, when the user inserts a plug into the digital camera first, the user is confused whether the Mini-A plug or the Mini-B plug should be inserted first.

For example, a Mini-B plug is inserted into the Mini-AB receptacle of the digital camera that is the dual-role device. In this case, the plug of the external storage side is the Mini-A plug. The user notices that the insertion direction of the cable is incorrect only after the user finds that the shape of the connector of the external storage is the Mini-B receptacle. In such a case, the user has to disconnect the Mini-B plug from the digital camera and connect a cable over again. Such operation is troublesome.

Moreover, since one end of the cable is correctly inserted into the digital camera, the user may misunderstand that the Mini-A plug can be inserted into the external storage side. If the user continues to have the misunderstanding, and forcedly tries to insert the Mini-A plug into the Mini-B receptacle of the external storage, the connection part of the device can be damaged.

Thus, either the Mini-A plug or the Mini-B plug can be physically inserted into the Mini-AB receptacle of the dual-role device, and it is difficult for the user to determine which plug should be inserted. It is highly possible that incorrect connections occur.

### SUMMARY OF THE INVENTION

The present invention is directed to preventing an incorrect connection of devices by a user at an early stage.

According to the present invention, a notification is made to the user with regards to the type of a plug corresponding to an operation mode of an electronic apparatus. Accordingly, a user is prevented from incorrectly connecting devices at an early stage, and the user can save labor and time.

According to an aspect of the present invention, an electronic apparatus is provided which is configured to communicate with another device through a communication line. The apparatus includes a determination unit configured to determine an operation mode of the electronic apparatus; and a notification unit configured to notify a plug type of the communication line corresponding to the operation mode determined by the determination unit.

According to another aspect of the present invention, the determination unit determines whether the electronic apparatus is in an operation mode of a host device or in an operation mode of a peripheral device.

According to yet another aspect of the present invention, the electronic apparatus may further comprising a detection unit configured to detect the plug type of the communication line inserted into the electronic apparatus, wherein if the detection unit detects that a plug different from the plug type of the communication line corresponding to the operation mode determined by the determination unit is inserted into the electronic apparatus, the notification unit notifies that the type of the plug inserted into the electronic apparatus is incorrect.

According to still yet another aspect of the present invention, the electronic apparatus may perform communication based on the USB On-The-Go (OTG) standard using the communication line.

Additionally, according to another aspect of the present invention, a control method is provided for an electronic apparatus configured to communicate with another device through a communication line. The method includes determining an operation mode of the electronic apparatus; and notifying a plug type of the communication line corresponding to the determined operation mode.

Moreover, according to another aspect of the present invention, a computer readable medium is provided containing computer-executable instructions for controlling an electronic apparatus configured to communicate with another device through a communication line. Here, the medium includes computer-executable instructions for determining an operation mode of the electronic apparatus; and computer-executable instructions for notifying a plug type of the communication line corresponding to the determined operation mode.

According to exemplary embodiments of the present invention, since a plug type corresponding to an operation mode of an electronic apparatus is notified, an incorrect connection between devices by a user can be prevented at an early stage, and labor of the user can be saved.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a digital camera according to an exemplary embodiment of the present invention.

FIG. 2 is a flowchart illustrating an exemplary plug type display when a dual-role device carries out communication by a USB connection, according to an aspect of the present invention.

FIG. 3 is a view illustrating an exemplary operation to select an USB operation mode on a display screen of a digital camera, according to an aspect of the present invention.

FIG. 4 is a view illustrating an exemplary operation to guide insertion of a Mini-A plug, according to an aspect of the present invention.

FIG. 5 is a view illustrating an exemplary operation to notify incorrect insertion of a plug to a user, according to an aspect of the present invention.

FIG. 6 is a view illustrating an exemplary operation to guide insertion of a Mini-B plug, according to an aspect of the present invention.

FIG. 7 is a view illustrating an exemplary operation to notify incorrect insertion of a plug to a user, according to an aspect of the present invention.

FIG. 8 is a view illustrating a conventional connection between a digital camera and a printer using a cable which has a Mini-A plug at one end and a standard B plug at the other end.

FIG. 9 is a view illustrating a conventional connection between a digital camera and a printer using a cable which has a Mini-A plug at one end and a Mini-B plug at the other end.

FIG. 10 is a view illustrating a conventional connection between a digital camera and a personal computer using a cable which has a Mini-B plug at one end and a standard A plug at another end.

FIG. 11 is a view illustrating a connection between a digital camera and a personal computer using a cable which has a Mini-B plug at one end and a Mini-A plug at another end.

### DETAILED DESCRIPTION OF THE EMBODIMENTS

Various exemplary embodiments, features, and aspects of the invention will be described in detail below with reference to the drawings.

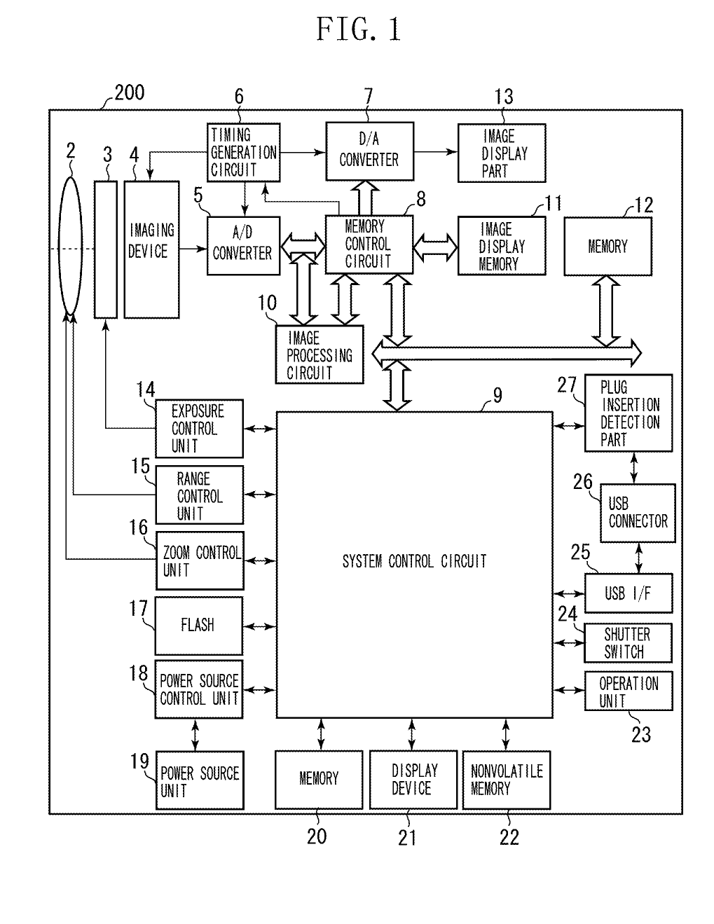

FIG. 1 is a view illustrating an example configuration of a digital camera according to an exemplary embodiment of the present invention. A digital camera 200 is in conformity with the USB OTG standard. Reference numeral 2 denotes a photo-taking lens. A shutter 3 is equipped with an aperture function. An imaging sensor 4 converts an optical image into an electronic signal. An A/D converter 5 converts the analog signal output of the imaging sensor 4 into a digital signal.

A timing generation circuit 6 supplies a clock signal or a control signal to the imaging sensor 4, the A/D converter 5, and a D/A converter 7, and the circuit is controlled by a memory control circuit 8 and a system control circuit 9. An image processing circuit 10 carries out a predetermined pixel interpolation processing or color conversion processing to the data from the A/D converter 5 or the data from the memory control circuit 8.

The memory control circuit 8 controls the A/D converter 5, the timing generation circuit 6, the image processing circuit 10, an image display memory 11, the D/A converter 7, and a memory 12. The data from the A/D converter 5 through the image processing circuit 10 and the memory control circuit 8, or the data from the A/D converter 5 directly through the memory control circuit 8, are written on the image display memory 11 or the memory 12.

Reference numeral 13 denotes an image display part which includes, for example, a TFT LCD. The image data for display written on the image display memory 11 is displayed by the image display part 13 through the D/A converter 7. When the captured image data is sequentially displayed using the image display part 13, an electronic finder function can be realized.

The memory 12 stores a captured still image or moving image, and is equipped with an adequate amount of storage capacity for storing predetermined frames of still images or a predetermined length of moving images. An exposure control unit 14 controls the shutter 3 having the aperture function, and cooperates with a flash 17 to perform also a flash adjustment function. A range control unit 15 controls focusing of the photo-taking lens 2, and a zoom control unit 16 controls zooming of the photo-taking lens 2.

The flash 17 has a floodlighting function with AF fill light and a flash adjustment function. The system control circuit 9 controls the digital camera 200, and a memory 20 stores, for example, a constant, a variable, and a program for operation of the system control circuit 9.

A power source control unit 18 includes a battery detection circuit, a DC-DC converter, a switch circuit for switching blocks to be energized. The power source control unit 18 detects a type of the battery, a remaining amount of the battery and whether a battery is mounted. According to the detected result and an instruction from the system control circuit 9, the power source control unit 18 controls the DC-DC converter, and supplies a necessary voltage for a necessary period of time to each part including a recording medium. A power source unit 19 includes a primary battery such as an alkaline battery or a lithium battery, a second battery such as a NiCd battery, a NiMH battery or a Li battery, or an AC adapter.

A display device 21 includes a liquid crystal display device, speaker or the like, which displays or indicates a moving state or a message using a character, an image, and a voice in response to execution of a program in the system control circuit 9. The single or a plurality of the display parts 21 are located in the vicinity of an operation part of the digital camera 200 at points where easily viewed, and configured by combining, for example, an LCD, an LED, and a sound production element.

A nonvolatile memory 22 can be electrically erased and recorded. An operation unit 23 is used for inputting various operation instructions of the system control circuit 9. The operation unit 23 is configured of, singly or a combination of, a switch, a dial, a touch panel, pointing by a visual line, or an audio recognition device, for example.

A shutter switch 24 instructs to start a series of processes for exposure and development. In the exposure process, a signal read out from the imaging element 4 is written as image data on the memory 12 through the A/D converter 5 and the memory control circuit 8. In the development process, calculation is performed in the image processing circuit 10 and the memory control circuit 8.

A USB interface 25 has a function as a dual-role device based on the USB OTG standard. Into the Mini-AB receptacle 26, either a Mini-A plug or a Mini-B plug specified by the OTG standard can be inserted. A plug insertion detection part 27 detects that a plug is inserted into the Mini-AB receptacle 26.

The digital camera 200 pursuant to the OTG standard is equipped with the Mini-AB receptacle 26. A device which operates as a peripheral device is equipped with a standard B receptacle or a Mini-B receptacle.

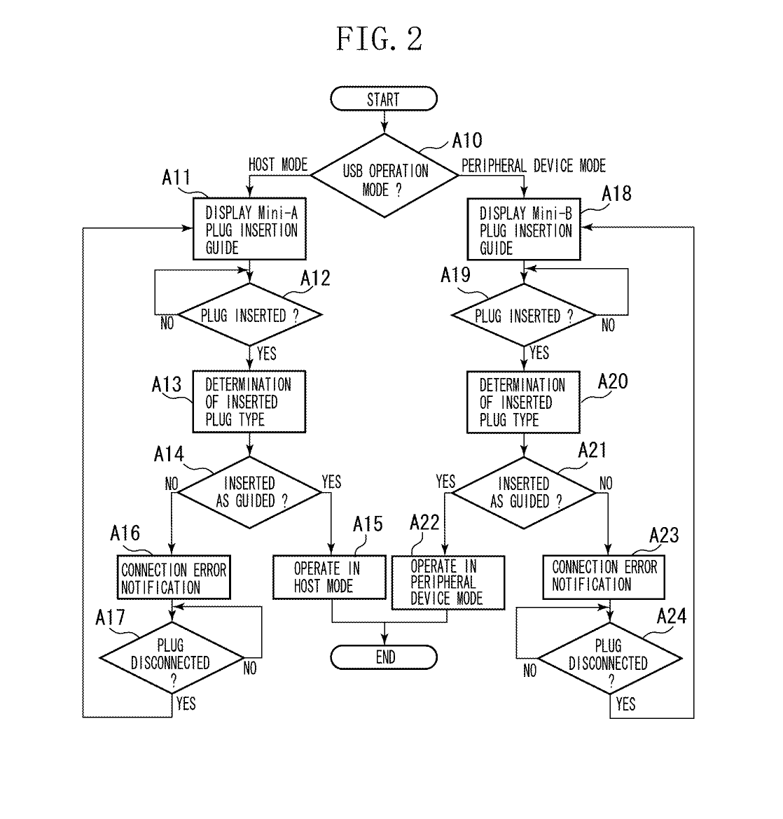

FIG. 2 is a flowchart illustrating an exemplary operation of notifying to a user a plug type usable in the digital camera 200 equipped with the Mini-AB receptacle, according to an aspect of the present invention.

After a power source of the digital camera 200 is turned on, a USB mode is selected. Then, the system control circuit 9 determines at step A10 whether the USB mode of the digital camera 200 is a host mode or a peripheral device mode. When the user starts up an application which operates the digital camera 200 as a host device or changes the mode switch to the host mode, the digital camera 200 enters the host mode.

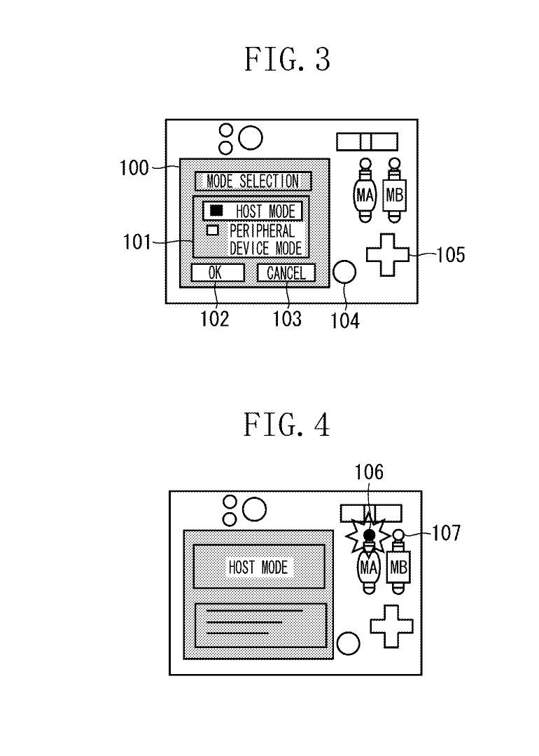

FIG. 3 illustrates selection of an exemplary operation mode in the digital camera 200. On a display screen 100 (corresponding to the display device 21 of FIG. 1), a list 101 of selectable operation modes is displayed, and the user can select a desirable mode using a direction key 105. After the user selects an operation mode, by selecting an OK button 102 and depressing a determination button 104, it is possible to enter the desired operation mode. The display screen 100 of FIG. 3 illustrates a state in which the host mode is selected. In this state, if the OK button 102 is selected and the determination button 104 is depressed, the system control circuit 9 controls the digital camera 200 to enter the host mode. If a cancel button 103 is selected and the determination button 104 is depressed, the system control circuit 9 stops the selection of the operation mode. If, by the user's operation, the operation mode of the digital camera 200 enters the host mode, the processing proceeds to step A11.

If the digital camera 200 enters the host mode, the system control circuit 9 carries out a guide operation (step A11) urging the user to insert the Mini-A plug into the Mini-AB receptacle so that the digital camera 200 operates as a host device. Then, the process proceeds to step A12.

FIG. 4 illustrates the guide operation urging the user to insert the Mini-A plug. An LED 106 indicates the Mini-A plug and an LED 107 indicates the Mini-B plug. The OTG standard specifies shapes of the Mini-A plug and the Mini-B plug. In this exemplary embodiment, drawings are displayed which represent each plug shape, and the user can readily understand that the LEDs indicate the Mini-A plug or the Mini-B plug. If the system control circuit 9 detects that the mode in the digital camera 200 has entered the host mode, the circuit 9 lights up the LED 106 which indicates the Mini-A plug, and performs display to urge the user to insert the Mini-A plug. The user sees the display and inserts the plug. Thus, when the user wants the digital camera 200 to operate as the host device, the Mini-A plug can be correctly inserted. It is to be understood that the guide operation is not limited to lighting-up the LED. For example, a display urging an insertion of the Mini-A plug can be displayed on the image display part 13. Moreover, the insertion of the Mini-A plug can be urged by voice.

In the process of step A11, when the digital camera 200 is in the host mode, the user is urged to insert the Mini-A plug and use a cable which has the Mini-A plug at one end. Thus, the user is prevented from using an incorrect cable. For example, some printers are equipped with both the standard A receptacle and the Mini-B receptacle so as to be able to operate as both a host device and a peripheral device. If the user wants to use the printer as the peripheral device and the digital camera 200 as the host device, a correct operation is to use a cable which has the Mini-B plug at one end and the Mini-A plug at the other end.

When the user inserts the Mini-B plug into the printer and the Mini-A plug into the digital camera 200, the digital camera 200 is connected as the host device. However, in the combination of the digital camera and the printer as described above, a cable can be used which has the standard A plug at one end and the Mini-B plug at the other end, because, into the printer, the standard A plug, and into the digital camera 200, the Mini-B plug can be physically inserted respectively. In such a case, the Mini-B plug is connected to the digital camera 200 which is expected to operate as the host device. On the other hand, if the printer to be connected is not a dual-role device, the printer cannot respond to the HNP and accordingly, cannot operate as the host device. In such a case, since the operable role is not in conformity with the inserted plug, the connection is incorrect. In this exemplary embodiment, if the dual-role device operates as the host device, an insertion guidance of the Mini-A plug is given which draws the user's attention. With this processing, the above incorrect connection at an early stage can be prevented.

However, even if the insertion of the Mini-A plug is urged by the guide display, the user can mistakenly insert the Mini-B plug into the Mini-AB receptacle of the digital camera 200, because the Mini-B plug can be physically inserted into the Mini-AB receptacle. Accordingly, in the flow described below, determination of the inserted plug and an error display at the time of incorrect connection are described.

At step A12, the digital camera 200 waits for a plug insertion by the user. When the system control circuit 9 determines that a plug is inserted into the digital camera 200, or a plug is inserted in advance, the process proceeds to step A13. At step A13, the system control circuit 9 determines a type of the inserted plug. Compared to the conventional USB standard connecter which has four terminals, a connecter based on the OTG has five terminals including a newly added ID terminal. With this ID terminal, the dual-role device can determine the type of the inserted plug.

In the Mini-A plug, the ID terminal is short-circuited to ground and in the Mini-B plug, the ID terminal is in a non-connected state. Upon detection of the plug insertion by the plug insertion detection part 27, the dual-role device starts to monitor the ID terminal in the Mini-AB receptacle. If the Mini-A plug is inserted, a change of the signal makes it possible to detect that the Mini-A plug is inserted. If the signal is not changed at the ID terminal when plug insertion is detected, it can be determined that the Mini-B plug is inserted. The plug insertion detection part 27 can detect the insertion of the plug, for example, by a mechanical switch which is changed by insertion of a plug.

With the above-described method, only when the plug at one end of the cable is inserted into the Mini-AB receptacle of the digital camera 200, the system control circuit 9 can determine the plug type at step A13.

At step A14, the system control circuit 9 determines whether the inserted plug corresponds to the plug urged in the guide display, i.e., whether the inserted plug is the Mini-A plug, in this case. If the inserted plug is the Mini-A plug, the processing proceeds to step A15, and the digital camera 200 operates as the host device by default. The cable which can be used in this case has the Mini-A plug at one end and has the standard B plug or the Mini-B plug at the other end. Accordingly, if the user inserts the Mini-A plug into the digital camera 200 operating as the host device, and inserts into the peripheral device the standard B plug or the Mini-B plug which corresponds to the receptacle shape of the peripheral device with which the camera 200 communicates, the connection is correctly performed and the communication can be carried out.

If the inserted plug does not correspond to the plug urged in the guide display, that is, it was the Mini-B plug, the inserted plug is incorrect. Then, an error notification is issued to the user (step A16).

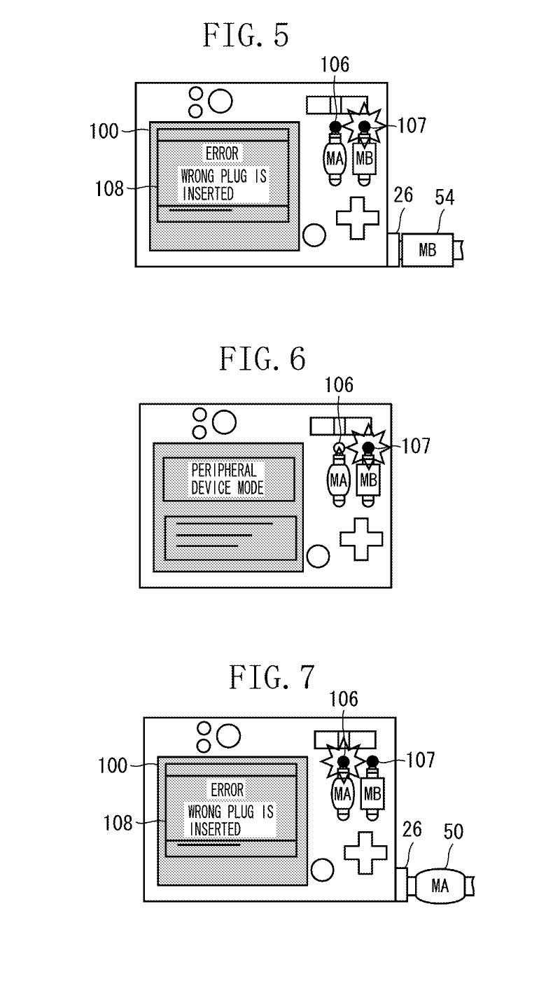

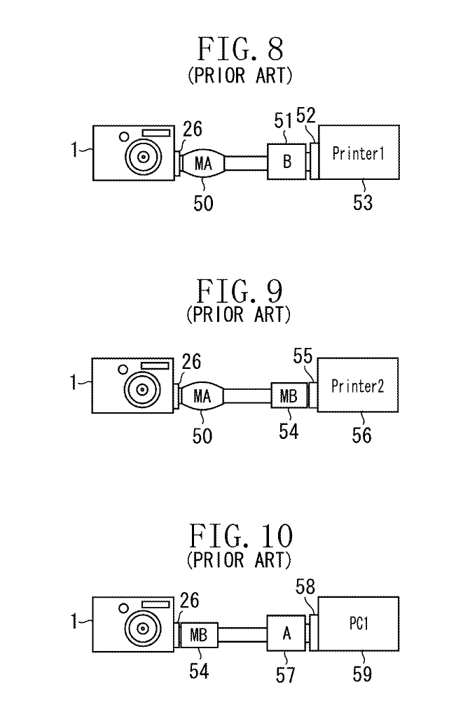

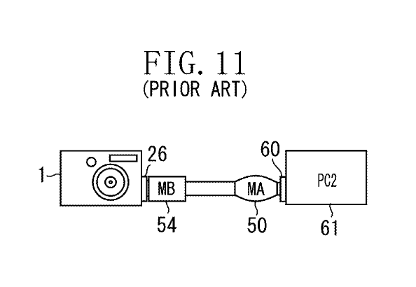

FIG. 5 illustrates the operation to notify the user that the Mini-B plug is mistakenly inserted. FIG. 5 shows that, although the system control circuit 9 lighted up the LED 106 which indicates the Mini-A plug, to urge the user to insert the Mini-A plug, the Mini-B plug 54 is inserted into the Mini-AB receptacle 26 by the user. In such a case, the system control circuit 9 causes the LED 107 indicating the Mini-B plug to blink or lights up the LED 107 in a color different from the LED 106 indicating the Mini-A plug. As described above, in this exemplary embodiment, the system control circuit 9 notifies the user that the plug different from the plug urged in the guidance is inserted, that is, the insertion is an error, and urges the user to insert the correct plug. Moreover, the system control circuit 9 produces a warning display 108 which indicates the inserted plug is incorrect, on the display screen 100. With the display, the system control circuit 9 notifies the user that the inserted plug is incorrect.

With the error notification, the user notices the error at the time that the user inserts one end of the cable, and can save labor and time to connect a correct cable again. For example, a cable is used which has the Mini-A plug at one end and the Mini-B plug at the other end, and the user connects the digital camera 200 with a device which has the Mini-B receptacle. In such a case, both the Mini-A plug and the Mini-B plug can be inserted into the digital camera 200.

Accordingly, even when the user wants the digital camera 200 to operate as the host device, the user can insert the Mini-B plug. In this case, the user will try to insert the Mini-A plug at the other end into the device which is to operate as the peripheral device, and search for a Mini-A receptacle. Then, only after the user notices that there is no Mini-A receptacle, he recognizes the mistake, and tries to make connection again. This operation is troublesome and burdensome for the user. Moreover, when the device to be operated as the peripheral device is equipped with the Mini-A receptacle and the Mini-B receptacle, even if the plugs to be inserted are reversed, the plugs can be inserted. However, the Mini-B cable is inserted into the digital camera 200 which is set to be the host mode. In this state, the insertion of the plugs is not in conformity with the operation mode.

Accordingly, it is possible that the communication cannot be performed or a communication error can occur. In such a case, it takes time until the user recognizes that the connection is incorrect, and moreover, the devices can be damaged due to the incorrect connection. Accordingly, the system control circuit 9 according to the exemplary embodiment determines the type of the plug at the time that the plug at one side of the cable is inserted, and if the type of the inserted plug is incorrect, the error notification is issued. Thanks to this processing, the incorrect connection can be prevented and the user can save labor and time to connect a correct plug over again.

After the notification of the incorrect connection is issued at step A16, the system control circuit 9 waits for the plug to be disconnected from the digital camera 200 at step A17. Then, if the plug insertion detection part 27 detects that the incorrect cable is disconnected, the processing returns to step A11 and the guidance for inserting the Mini-A plug is displayed again and the insertion of the Mini-A plug is urged. These processings are repeated until the plug is correctly connected.

So far, the digital camera 200 that operates as the host device has been described. Next, the digital camera 200 equipped with a Mini-AB receptacle that operates as a peripheral device will be described. The digital camera 200 is connected with the other device which operates as a host device.

The digital camera 200 is equipped with the Mini-AB receptacle, and the device which operates as the host device is equipped with the standard A receptacle or the Mini-A receptacle.

Now, with reference to the flowchart of FIG. 2, a display of a plug type when the digital camera 200 operates as the peripheral device, is described.

After a power source of the digital camera 200 is turned on, the system control circuit 9, at step A10, determines whether a USB operation mode of the digital camera 200 is a host mode or a peripheral device mode. If the user starts up an application which operates the digital camera 200 as the peripheral device or changes a mode switch to the peripheral device mode, the digital camera 200 enters the peripheral device mode.

In the operation method described above, when the user selects and determines the peripheral device mode from the operation mode list 101 in FIG. 3, the digital camera 200 enters the peripheral device mode. At step A10, if the system control circuit 9 determines that the operation mode is the peripheral device mode, the processing proceeds to step A18.

Since the digital camera 200 is in the peripheral device mode, the Mini-B plug has to be inserted into the Mini-AB receptacle. Then, at step A18, the system control circuit 9 performs a guide operation to urge the user to insert the Mini-B plug so that the digital camera 200 operates as the peripheral device.

FIG. 6 illustrates the guide operation to urge the user to insert the Mini-B plug. If the system control circuit 9 detects that the digital camera 200 has entered the peripheral device mode, the system control circuit 9 lights up the LED 107 indicating the Mini-B plug and urges the user to insert the Mini-B plug (step A18). The user sees the display and connects the plug. If the user wants the digital camera 200 to operate as the peripheral device, the Mini-B plug can be correctly inserted. It is to be understood that the guide operation is not limited to lighting-up the LED. For example, a display urging insertion of the Mini-B plug can be shown on the image display part 13. Moreover, the insertion of the Mini-B plug can be urged by voice.

In the process of step A18, if the user is urged to insert the Mini-B plug and use a cable which has the Mini-B plug at one end, the incorrect connection using the incorrect cable can be prevented. For example, some printers are equipped with both the standard A receptacle and the standard B receptacle. If the user wants to use the printer as the host device and the digital camera 200 as the peripheral device, a correct operation is to use a cable which has the standard A plug at one end and the Mini-B plug at the other end and insert the standard A plug into the printer and the Mini-B plug into the digital camera 200.

However, in the combination of the digital camera and the printer as described above, a cable which has the standard B plug at one end and the Mini-A plug at the other end can also be used, because into the printer, the standard B plug, and into the digital camera 200, the Mini-A plug can be physically inserted respectively. In such a case, although the devices are physically connected, the standard B plug is connected to the printer which is expected to operate as the host device. Moreover, if the printer is not a dual-role device, it is not possible to request the HNP and accordingly, the printer cannot operate as the host device. In such a case, since the operable role of the device is not in conformity with the inserted plug, the connection is incorrect.

Accordingly, the system control circuit 9 according to the exemplary embodiment carries out the guidance to insert the Mini-A plug and prevents the use of the incorrect cable in advance. Thus, the types of cables to be used are limited, the operation of the user becomes cleare, and the incorrect connection between the devices can be prevented.

However, even if the insertion of the Mini-B plug is urged by the guide display, the user can mistakenly insert the Mini-A plug into the Mini-AB receptacle of the digital camera 200, because the Mini-A plug can be physically inserted into the Mini-AB receptacle. Accordingly, in the flow described below, determination of the inserted plug and an error display at the time of the incorrect connection are described.

At step A19, the plug insertion detection part 27 waits until a plug is inserted into the digital camera 200. If it is determined that a plug is inserted into the digital camera 200, the process proceeds to step A20. At step A20, the type of the inserted plug is determined.

At step A21, the system control circuit 9 determines whether the inserted plug corresponds to the plug urged in the guide display, in this case, whether it is the Mini-B plug. If the inserted plug is the Mini-B plug as urged in the guide display, the processing proceeds to step A22, and the digital camera 200 operates as the peripheral device by default. The cable which is used in this case has the Mini-B plug at one end and the standard A plug or the Mini-A plug at the other end. Accordingly, if the user inserts the Mini-B plug into the digital camera 200 operating as the peripheral device, and inserts into the communicating device the standard A plug or the Mini-A plug that corresponds to the receptacle shape of the communicating device operating as the host device, the connection is correctly performed and the communication can be carried out.

If the inserted plug does not correspond to the plug urged in the guide display, that is, if the inserted plug is the Mini-A plug, since the inserted plug is incorrect, the system control circuit 9 issues an error notification to the user (step A23).

FIG. 7 illustrates the operation to notify the user that the Mini-A plug is mistakenly inserted. FIG. 7 shows that, although the LED 107 indicating the Mini-B plug was lighted up to urge the user to insert the Mini-B plug, the Mini-A plug 50 is inserted into the Mini-AB receptacle 26 by the user. In such a case, the system control circuit 9 causes the LED 106 indicating the Mini-A plug to blink or lights up the LED 106 in a color different from the LED 107 indicating the Mini-B plug. As described above, in this exemplary embodiment, the system control circuit 9 notifies the user that the plug different from the plug urged in the guide is inserted, that is, the insertion is an error, and urges to insert the correct plug. In this exemplary embodiment, a warning display 108 which indicates that the inserted plug is incorrect, is produced on the display screen 100. With the display, the user is notified that the inserted plug is incorrect.

With the error notification, the user notices the error at the time that the user inserts one end of the cable, and can save labor and time to connect a correct plug again. For example, a cable is used which has the Mini-A plug at one end and the Mini-B plug at the other end. The user connects the digital camera 200 with a personal computer which has only a Mini-A receptacle to operate as a host device. In such a case, it is possible that the Mini-A plug is inserted into the digital camera 200 which is expected to operate as a peripheral device. Then, the user will try to insert the Mini-B plug at the other end of the cable into the personal computer, and search for a Mini-B receptacle. Only after the user notices that there is no Mini-B receptacle, he recognizes the mistake, and tries to make connection again. This operation is troublesome and burdensome for the user.

Accordingly, the system control circuit 9 according to the exemplary embodiment determines the type of the plug at the time that the plug at one side of the cable is inserted, and if the type of the inserted plug is incorrect, the error notification is issued. Thanks to this processing, the user can save labor and time to connect a correct plug over again.

Further, according to the exemplary embodiment, if the user wants the digital camera 200 to operate as the peripheral device, the system control circuit 9 performs the guide display to urge the user to insert the Mini-B plug. Further, at the time that the Mini-A plug is mistakenly inserted, the error display appears. As a result, the incorrect connection between devices can be prevented. For example, when a cable is used which has the Mini-A plug at one end and the Mini-B plug at the other end, the user can mistakenly insert the Mini-A plug into the digital camera 200 which is expected to operate as a peripheral device and insert the Mini-B plug at the other end into a device which has the Mini-B receptacle. In such a case, even though the digital camera 200 is expected to operate as the peripheral device, the digital camera 200 is connected to the device which operates only as the peripheral device. That is, the peripheral devices are connected with each other, but a correct communication may not be performed. However, physically, it looks like to the user that the cable is correctly connected, and it is difficult to recognize that the connection is incorrect from a functional point.

Accordingly, the system control circuit 9 according to the exemplary embodiment produces the error display at the time that the plug at one side of the cable is mistakenly inserted. Accordingly, the incorrect connection of the cable can be prevented in advance.

After the system control circuit 9 issues the notification of the incorrect connection at step A23, the circuit 9 waits for the plug to be disconnected from the digital camera 200 at step A24. Then, when the plug insertion detection part 27 detects that the incorrect cable is disconnected, the process returns to step A18 and the system control circuit 9 displays again the guidance for inserting the Mini-B plug and urges the insertion of the Mini-B plug. These processings are repeated until the plug is correctly connected.

As described above, according to the exemplary embodiment, since the connectable plug is explicitly indicated to the user, the incorrect connection of the plug can be prevented and the clear device connection method can be provided to the user.

An aspect of the present invention can also be achieved by providing the system or the device with a storage medium which records a program code of software implementing the function of the exemplary embodiment and by reading the program code from the storage medium and executing the program with a computer of the system or the like.

In this case, the program code itself, which is read from the storage medium, implements the function of the exemplary embodiment mentioned above, and accordingly, the storage medium storing the program code constitutes the present invention.

As the storage medium for supplying such program code, for example, a flexible disk, a hard disk, an optical disk, a magneto-optical disk, a CD-ROM, a CD-R, a magnetic tape, a nonvolatile memory card, and a ROM can be used.

In addition, the function according to the embodiments described above is implemented by the processing in which an OS which operates on the computer or the like carries out a part of or the whole of the actual processing on the basis of the instruction of the program code read by the computer.

Further, in another aspect of the exemplary embodiment of the present invention, after the program code read from the storage medium is written in a memory which is provided in a function enhancing unit or the like connected to the computer, the CPU or the like carries out the actual processing on the basis of the instruction of the program code to implement the function of the exemplary embodiment as described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application Nos. 2006-006291 filed Jan. 13, 2006, 2006-343246 filed Dec. 20, 2006 which are hereby incorporated by reference herein in their entirety.

What is claimed:

1. An electronic apparatus configured to communicate with another device through a communication line, the apparatus comprising:
a determination unit configured to determine an operation mode of the electronic apparatus; and
a notification unit configured to notify a plug type of the communication line corresponding to the operation mode determined by the determination unit.

2. The electronic apparatus according to claim 1, wherein the determination unit determines whether the electronic apparatus is in an operation mode of a host device or in an operation mode of a peripheral device.

3. The electronic apparatus according to claim 1, further comprising:
a detection unit configured to detect the plug type of the communication line inserted into the electronic apparatus,
wherein if the detection unit detects that a plug different from the plug type of the communication line corresponding to the operation mode determined by the determination unit is inserted into the electronic apparatus, the notification unit notifies that the type of the plug inserted into the electronic apparatus is incorrect.

4. The electronic apparatus according to claim 1, wherein the electronic apparatus performs communication based on the USB On-The-Go (OTG) standard using the communication line.

5. A control method of an electronic apparatus configured to communicate with another device through a communication line, the method comprising:
determining an operation mode of the electronic apparatus; and
notifying a plug type of the communication line corresponding to the determined operation mode.

6. A computer readable medium containing computer-executable instructions for controlling an electronic apparatus configured to communicate with another device through a communication line, the medium comprising:
computer-executable instructions for determining an operation mode of the electronic apparatus; and
computer-executable instructions for notifying a plug type of the communication line corresponding to the determined operation mode.
